(19) United States
(12) Patent Application Publication
(10) Pub. No.: US 2021/0138952 A1
(43) Pub. Date: May 13, 2021

(54) Tow-Behind Rotary Spreader Driver Seat Operated Discharge Chute Control

(71) Applicants: Gary Michael Petrillo, SR., Wallingford, CT (US); Gary Michael Petrillo, JR., North Haven, CT (US)

(72) Inventors: Gary Michael Petrillo, SR., Wallingford, CT (US); Gary Michael Petrillo, JR., North Haven, CT (US)

(21) Appl. No.: 16/780,991

(22) Filed: Feb. 4, 2020

Related U.S. Application Data
(63) Continuation of application No. 62/933,600, filed on Nov. 11, 2019.

(51) Int. Cl. B60P 3/22; B60P 1/56; B60P 3/30

(52) U.S. Cl. CPC B60P 3/225; B60P 1/56; A01C 17/001; B60P 3/30; B60P 3/223; B60P 3/2245

(57) ABSTRACT

This abstract is based on an alternate, improvement control method, to assist the drivers who have had, or recently discovered they have hand or finger disabilities and can no longer use our easy grab ball control disc, because it is too difficult for them to pull against some of the low-end spreader models that use very heavy springs to keep the tow-behind spreader center-column-handle-lever in place, each time the slide gate porthole chute is repositioned.

This alternate control method consists of two (2) improved modified control discs, that incorporates (fulcrum pivot mechanics) to be used in the event the operator's hand has arthritis, carpel tunnel, difficulty in closing fingers, fist, or other hand deficiencies, which makes them unable to pull and use our original twine line grab ball control disc, against the heavy force of those springs installed by the manufacturer.

These two (2) improved fulcrum-pivot-design controls will make it very easy for the driver to still open and close the slide gate porthole chute from the d river's seat, because they use (fulcrum physics) less force to move a heavier load.

### CROSS REFERENCE TO RELATED APPLICATIONS

This application claims the benefit of U.S. NON Provisional Allocation No. 16/780,991 filed on Feb. 4 2020

This material is a Continuation In Part with Application Number 16/780,991

### BRIEF DESCRIPTION

### Control Disc Improvement: Driver Operated

There are presently 25 tow-behind spreaders that can use our user-installed Tow-Behind Driver Seat Operated Slide Gate Chute Control Hardware Kit, to position the slide gate chute from the drivers seat. However, there are a few low-end rated spreaders where the manufacturer uses heavy springs, as well as nylon spring-pressured washers to squeeze the lower portion of the original manufactures' spreader handle lever, so when the handle lever is moved, by the user, it stays (put) in that position. This, of course, requires the operator to use much more force on their hand and finger joints to apply enough pressure to move and reposition the slide gate chute. Thus, a person with arthritis or other hand squeezing difficulties may be unable to use our original grab-ball control disc method. To better suit these individuals with hand or finger disabilities, we have designed two (2) alternate control disc methods as a (continuation in part) with improvements that uses a fulcrum, (pivot mechanics) design, which enables the user, from their drivers' seat, to easily compensate for the firm spring tension and pressure applied to the washers on the handle axle, without asserting very much pressure on their fingers, hand joints or similar hand deficiencies, to easily open and close the slide gate chute. For this reason, the improvement of these two Fulcrum Control user-installed kits is used to help the user to apply less force to move, a heavy load.

### BRIEF DESCRIPTION OF DRAWINGS

FIG. 1. Controller Type 1: Round pulley and handle lever (Fulcrum Pivot Control)

FIG. 2. Controller Type 2: Long handle with pivot arm (Fulcrum Pivot Control)

FIG. 3. Detailed pulley (Fulcrum Pivot Control) Type 1

FIG. 4. Detailed handle (Fulcrum Pivot Control) Type 2

FIG. 5. Hardware aid fastener detailed assembly references

### BRIEF DESCRIPTION-PULLEY-FULCRUM-CONTROL

FIG. 1

The embodiment of this improved control disc device (56) is mounted on the end of our support shaft (27) at the drivers' seat, is comprised of a round disc, with a center groove, much like a pulley, but not limited to a tubule roll, or part of a tubular dish shaped disc or circular shaped object to wrap or coil a preferred nylon twine around, but not limited to, cord, rope, wire, sheathed cable or similar flexible line, that can shorten and lengthen by rotating, pulling or pushing movement to move the twine-line back and forth, but not limited to six (6) inches, has a handle lever attached (54) for the drivers hand to push, using the fulcrum pivot, to rotate the said pulley, which will then pull the said twine through various pulleys, mounted on the spreader, to pull and operate the slide gate discharge chute from the drivers' seat.

### Detailed Description-Pulley-Fulcrum-Control

FIG. 1

“Note”: For clarity, our shaft (27) is not fully shown and the two double pulleys (set 32 and set 33) are separated so it is easier to visualize how the twine line travels through the double pulleys, mounted on the spreader.

Our support shaft (27) is mounted with straps (28) just as before, to the side of the spreader hopper and places the other end of the shaft and the control pulley (to be easily reached) at the drivers' seat. At the drivers seat (DETAIL FIG. 3) is a grooved pulley shaped circular control disc (56) with an attached handle lever (54) comes pre-assembled to the end of our support shaft with a bolt (57) lock washer, nylon washer and non-slip nut. A double swivel pulley (32T) and (32B) FIG. 1, for our twine-line, is bolted to the shaft using a conduit strap, located further down the shaft (27) in line with the front of the plastic hopper. In line with those two double pulleys and fastened to the top of the plastic hopper with screw, lock washer and non-slip nut is an (L) bracket. This (L) bracket connects another set of double swivel pulleys (33T) and (33B). The spreader handle gets a clamp on (36) U bolt with loop rings, so there's no steel to drill. Bolted to the tow bar (22) is an existing bolt (38A) which connects the to r bar to the tractor hitch. We attach an (L) bracket (38) to existing bolt (38A) and mount a single swivel pulley (30C) for our twine (48), For reference; on drawing FIG. 1-A, the slide gate unit (10) has an open slide gate porthole chute (8). And, drawing FIG. 1-B below, the slide gate (10) has a closed slide gate chute (9). The hardware kit components are now all attached to the spreader.

### Detailed Specifications of the Invention with Method of Operation

FIG. 1-A: Lacing of the twine-line (48). First we set the handle lever (6) so that the slide gate chute porthole is open (8) (FIG. 1-A) and the granular product flow adjustment (12) is “fully” open to maximum position. We set fulcrum handle lever (54) FIG. 3A located on control pulley (56) facing upwards, until the stop bolt (67A) rests against the upper portion of our support shaft (27). Our twine line (48C) FIG. 1A is first attached to the shaft mounted control pulley (56) onto a tie off hole (70) located on the fulcrum handle lever (54) that is facing upwards. The other end of that twine-line (48C) proceeds down and around the upper double pulley (32T) mounted on our shaft (27) then over to the upper double pulley (33T) mounted on the spreader top wall and then connects and ties off (with no slack) onto our U-bolt clamp (36) rear facing (loop ring) mounted to the top of handle lever (6) as shown. This handle lever (6) is the original manufacturers' hand-held lever that moves the connecting rod (4) that moves the slide gate chute unit (10) to force the slide gate porthole chute to open and close.

We now take the other new cut end of the twine-line (48D) and tie it to spreader handle lever (6) to our U-bolt clamp (36) to the other front facing (loop ring). The twine-line (48D) continues downward over to the single swivel pulley (30C) located on the tow bar, then returns through the spreader attached lower pulley (33B) then continues over to the lower pulley (32B) attached to our support shaft. After the twine-line (48D) leaves the pulley (32B) it continues freely along the shaft (27) up to, and connects to our fulcrum pulley control disc (56) at the drivers' seat to the same handle (54) tie off hole (70) where the twine-line (48C) originally started from. Our owner's installation instructions will show that the stop pin (57A) FIG. 3A on the control pulley (56) must stay hitting and resting on the top of our support, shaft (27) and then the user can pull the twine-line (48D) taught and tie it off. Both ends of the twine-line are tied to the pulley connection hole (70) so the twine does not slip when the pulley is rotated. The twine-line lacing is complete.

The twine-line is attached to all the pulleys and our fulcrum pulley in a continuous loop, whereas, when the fulcrum pulley rotates to pull the twine-line in one direction, it also rotates and release the twine-line in the opposite direction. There is one (1) stop bolt (57A) through the pulley that hits the support shaft when the slide gate (10) porthole chute is open (8) and a pulley-through-bolt (57B) which attaches handle to pulley, is a stop pin as well, when it hits the support shaft (27) when the pulley handle lever (64) is pointed downward and the slide gate (10) porthole chute (9) is closed FIG. 1-B. The stop bolt is primarily used for setting, up the twine in the open and closed slide gate position before tying it off onto the pulley hole (70). In FIG. 1-B when the driver chooses to close the slide gate unit (10), they simply move and rotate the fulcrum pulley control handle lever (54) downward FIG. 1-B, and the fulcrum control pulley starts pulling on the twine (48C) which then pulls the spreader hand le lever (6) back towards the hopper and the slide gate porthole chute (9) closes. The stop bolts (57A) and (57B) is a precaution to prevent the pulley from over compensating however, the pulley will not move any farther once the slide gate chute unit (10) is closed (9) or (8) is open. The operator can always adjust the granular products' flow rate.

The operator uses the control pulley (56), with its fulcrum long handle (54) (Fulcrum Pivot Physics) to apply less force to move a heavy load created by the tension of the manufacturers pressure spring washers. This, of course, reduces pressure to their hand squeezing issues, arthritis, or other finger disabilities when they need to reposition the slide gate porthole chute.

### Brief Description Handle-Pivot-Fulcrum Control Type 2

FIG. 2

The embodiment for this control handle lever (DETAIL FIG. 4) is comprised of a straight handle (62), preferred to be, but not limited to six (6) inches long with a 90 degree shorter arm (58), preferred to be, but not limited to two 2 inches long in an (L) shaped configuration, where, at their axis point is a pivot bolt (64) that fastens the (L) shaped fulcrum handle lever (62) to the support shaft (27) at the drivers seat with a bolt, lock washer, nylon washer, and stop nut, which now creates a fulcrum lever to move heavy loads with less force. This embodiment, comprising of a straight handle with an (L) shaped arm, allows a longer length of twine-line to be pulled by the handle lever, because its shape enhances the travel path to produce a longer “throw” to move the slide gate (10) FIG. 2 position back and forth, but is not limited to a straight handle lever, without a 90 degree (L) shaped arm, having the same fulcrum pivot properties, in the same manner, so as to pull enough length of twine or wire to reposition slide gate chute (10). This fulcrum handle control (62) allows the driver to open and close the slide gate chute from the drivers' seat. It is this longer handle lever that they use to pull or release the twine-line that is connected through various pulleys, attached to the spreader, to move the spreaders handle lever (6) that moves the connecting rod (4) h a opens and closes the slide gate chute (10). The longer handle lever (62) that pivots, enables the driver to easily move, using fulcrum pivot physics, the shorter 90 degree arm, to pull and release the twine-line in a backwards and forwards movement to create more force to open and close the slide gate unit (10) with less applied effort,

The embodiment of the twine-line is preferred to be multiple stranded nylon twine, being thin, yet strong, to operate smoothly, with directional changes, through all the pulleys, but not limited to a cord, rope, sheathed cable, similar flexible line, or wire that can be pulled, pushed, or wound, and released by a pulley, through a loop, or pulled and pushed through a sheath to reposition the slide gate porthole chute. Further, because of the pressured spring-tens on washers, on these low-end models, it is sometimes necessary to simultaneously use two (2) small bungee cords, pulling parallel together, so to have enough pulling tension needed to force and pull the spreader handle lever (6), to move the closed porthole chute (9) back to open position (8). Moreover, pulling two bungee springs will be ne problem using fulcrum pivot mechanics.

### Brief Description Handle-Pivot-Fulcrum Control Type 2

FIG. 2-A

The support shaft (27) is, bolted through the spreader plastic hopper with straps (28) bolts, lock washers and stop nuts, so that the handle control lever (62) is next to the driver's seat elbow without anything touching the pulling vehicle. The handle lever, DETAIL FIG. 4 (62) is pre-attached to the support shaft (27) and is facing upwards and the shorter arm (58) is resting on a stop pin (60) that is bolted through the support shaft (27) to prevent the short arm (68) from moving any further. The spreader mounted, handle lever (6) FIG. 2-A, on the tow bar frame (4 is being pulled back from the bungee cord (40) tension that is tied between handle lever (6) U-bolt (36) ring and over to the (L) bracket on the tow bar bolt (38). This FIG. 2A shows the slide gate unit (10) has an open porthole (8). Swivel pulley (30A) is attached to our support shaft (27) with a strap and is in line with swivel pulley (30B) which is fastened with a bolt, washer, and stop nut to the top of the spreader plastic hopper in line with handle lever (6) The kit hardware components are all attached.

### Detailed Specifications of the Invention with Method of Operation

FIG. 2 Method Of Operation

Our installation manual will direct the user to open the flow rate setting (12) to its maximum open position and to place the control hand lever (62) at the drivers' seat, in a downward position FIG. 2-B. The lacing of the twine-line (48) begins where one end of the twine-line (48) is first tied off to a small hole (58A) DETAIL FIG. 4B, in the short 90 degree arm (58) attached to control handle (62). The twine-line (48) then continues through the shaft mounted pulley (30A) FIG. 2B then over to spreader mounted pulley (30B) and then over to our U-bolt clamp (36) rear facing (loop ring) on the spreaders handle (6). We then pull “tightly” on the twine-line (48) until the spreader handle lever (6) forces the connecting rod (4) to close the porthole chute (9) FIG. 2B and then tie off the twine-line (48) and cut it. “NOTE” the twine (48) has been pulled real tight now because the stop pin (80) is hitting the long control arm (62) FIG. 2B The only way the twine-line (48) can get enough slack to move backwards, to open the slide gate chute porthole (8), is when the operator lifts the control handle lever (62) upwards, which pivots the short arm (58) upwards as well, to release enough twine-line (48) to reposition the slide gate chute porthole to open (8) as is FIG. 2-A. It is this bungeecord (40) tension that pulls on the spreader handle lever (6) towards the pulling vehicle, that tugs on the twine-line to pull enough slack backwards, to open the slide gate chute (8) FIG. 2-A.

To simplify this operation FIG. 2-B The twine-line (48) was pulled tight and tied off between the spreader handle lever (6) and the operator control short pivot arm (58). There is no more twine slack. The slide gate connecting rod (4) cannot move back from the pulling force of the bungee cord (40) because the fulcrum pivot handle lever (62) has been (pinned) (60) to stop, thus the slide gate chute (9) stays closed without any further assistance from the operator. All twine lacing is complete.

Looking at FIG. 2A, the slide gate chute is open (8) and the fulcrum handle (62) is facing upwards. When the driver is ready to close the slide gate unit (10) from their seat, they push downward on the long, handed lever FIG. 2-B (62). The twine-line now starts pulling through single swivel pulley (30A) and (30B) and tugs on U-bolt (36) and (loop ring) clamped to spreader handle (6) and starts to force the connecting rod (4) connected to the slide gate unit (10) to push and move the slide gate porthole chute to close (9) FIG. 2-B. Once the small arm (58) pivots and passes the center of the support shaft (27) it hits the stop pin (60) again FIG. 4B. The arm (58) is now forced to stay in that position because the bungee cord (40) is pulling and applying tension on the twine. Thus the slide gate unit (10) stays in the closed (9) position without any further assistance from the driver. When the driver wants to open the slide gate porthole chute again FIG. 2A they move the handle lever (62) upward and the slack of the twine-line (48) pulls backwards because of the bungee cord (40) tension. The slack moving backwards, towards the spreader causes spreader handle lever (6) to move the opposite way and forces the slide gate porthole chute to open (8) as in FIG. 2-A. Moreover, handle lever (62), by applying fulcrum pivot physics properties, allows the driver to use less force to move a heavier load, that being, the heavy squeezing tension-washers installed by the manufacturer.

### SUMMARY

All of the “original user installed kit” hardware embodiments and claims, consisting of: the support shaft, straps, L brackets, swivel pulleys, nylon twine, control disc, grab ball, and bungee cord remain the same, which enables the driver to open and close the spreader discharge chute from the driver's seat.

This (Continuation In Part) offers two (2) distinct and very important operator control improvements. That being, the use of fulcrum pivot mechanics, to aid the operator who may have been inflicted with a hand disorder and can no longer move the, control disc grab ball controller, due to heavy pressure caused by the manufactured springs, on some of the low end tow-behind spreader models. These two (2) fulcrum pivot hardware user-installed kits can be ordered NEW, or can be substituted to only replace our original grab-ball control disc, on their spreader, at a later date, if the operator experiences deficiencies in their hand and is unable to move past the tight spring pressure-washers, using our original grab ball control disc kit, on their original spreader, or, a “newer” model that they may have recently purchased. And, as claimed before, all of the kits are removable and reusable, with just a minor adjustment.

Further, the embodiment of these two user-installed fulcrum pivot controls will have the option of being fully attached to the support shaft, in a complete, originally ordered kit, or, be ordered separately, as an add-on, which includes the required hardware, “plus” an (added coupling) DETAIL FIG. 4 & FIG. 3, (72) to attach the fulcrum control unit they choose, to easily adapt and mount onto our original support shaft, to replace our original grab ball control disc model.

### Sequence of Operation

### Fulcrum “Pulley” Handle

FIG. 1-A The Control disc handle at the drivers' seat facing upwards (54) and the slide gate chute porthole is open (8). When the driver wants to close the slide gate porthole chute, and stop the flow of granular product, he merely pushes downward on the handed lever (54) forcing the fulcrum pulley (56) to pull the twine line (48C) downwards FIG. 1-B (clockwise rotation) which closes the slide gate porthole chute closed (9). The slide, gate porthole chute remains closed (9) and handle lever (54) remains in a downward position with no more assistance from the operator.

FIG. 1-B When to driver wants to open the slide gate chute porthole, and start the flow of granular product again, they merely pull upwards on the pulley fulcrum handle lever (54) forcing the fulcrum pulley (56) to pull the twine line (48D) upward FIG. 1-A (counter clockwise rotation) which pulls the spreader handle (6) towards the pulling vehicle, FIG. 1-A which pulls the connecting rod (4) to open the slide gate porthole chute to open (8), with no further assistance from the operator. Both stop pins (57A) and (57B) keep the fulcrum handle (56) from moving and over-rotating too far in both directions.

Thus, to simplify: with the “handle Up” the granular product flows. With the “Handle Down” the granular product flow is halted (stops).

### Sequence of Operation

### Fulcrum “Pivot” Handle

FIG. 2-A The fulcrum control handle lever at the drivers' seat is facing upwards (62) and the slide gate chute porthole is open (8). When the driver wants to close the slide gate porthole chute, and stop the flow of granular product, he merely pushes downward on the fulcrum handed lever (62) forcing the fulcrum handle lever (58) to pull the twine line (48) tied to the short arm hole (58A) forwards and downwards FIG. 2-B which pulls on the spreader handle lever (6) forcing the connecting rod (4) to close the slide gate porthole chute closed (9). The slide gate porthole chute remains closed (9) and handle lever (62) remains in a downward position. The stop pin (60) FIG. 2-B prevents the handle lever (62) from moving any further, in this downward position, and the short fulcrum arm (58) and the twine tie off (58A) stays in place and keeps the twine (48) taught without any further assistance from the operator.

FIG. 2-B When the driver wants to open the slide gate porthole, and start the flow of granular product again, he merely lifts upward on the handed lever (62) forcing the fulcrum handle short arm (58) to pull the twine line (48) tied to the hole (58A) up and around FIG. 2-A. This moves enough twine slack backwards towards the spreader and the slide gate porthole chute tis now open (8). The slide gate porthole chute remains open FIG. 1-A (8) and handle lever (62) remains in an upward position with no more assistance from the operator.

The stop pin (60) keeps the fulcrum handle (62) from moving too far in both directions. Thus, to simplify: with the “handle Up” the granular product flows. With the “Handle Down” the granular product flow is halted (stops).

FIG. 5, shows the spreader fastening details that are used in the self-installed kits.

What is being claimed:

1. I claim the object of the tow-behind rotary spreader driver seat operated discharge chute control invention is to instantaneously control the release of granular product discharge, directly near the driver's seat elbow, whereas, the apparatus of enhancement containing hardware attachment components, comprising of a kit, having a metal supporting shaft, metal fastening straps, bolts, nuts, washers, swivel pulleys, bungee cord spring, nylon twine, (L) shaped bracket loops, operator grab ball, and an improved controlling device, in conjunction with a plastic control disc, that being, to locate the products discharge chute porthole device, to control the on/off flow of product, directly from the driver's seat, while driving and facing forwards, comprising of the embodiments of the invention in which exclusive elements of hardware, their arrangement, purpose and their functionality is claimed.

2. As per claim 1, a device being the support shaft, comprising; a dimensional stability, is preferred to be metal, round tubular shape, so as not to bend or flex, is fastened to the spreader in such a manner, to locate the end of the shaft, having the plastic control disc, next to the driver's seat, whereas;
a) the said shaft can be mounted on the left or right hand side of the spreader depending on the operators right or left handed preference.

3. As is claim 1, The device fastening, comprising: metal fastening straps and bolts are the preferred fastening method for the metal support shaft, whereas;
a) the straps allow sliding and shifting and easier positioning of the metal support shaft so the plastic control disc can be effectively located next to the driver's seat shoulder without touching the seat, whereas;
b) the metal straps also allows repositioning of the metal support shaft, and its plastic control disc to another pulling vehicle, thus, not limiting it to just one pulling vehicle, if the original vehicle is being repaired or out of commission.

4. As per claim 1, a device, being a plastic control disc, is preferred comprising: a hold and release mechanism the operator uses to control the opening and closing of the slide gate discharge chute, is mounted on the end of the support shaft next to the driver's seat, is the main controller for the method of moving the position of the slide gate discharge chute, to the open or closed position, whereas;
a) a plastic control disc, comprising of a large opening above for twine to pass through freely with an adjoining smaller thin slot opening below that will not allow a twine knot or protuberant to pass through, is mounted on the end of the metal shaft on a (45 degree) angled pitch, so that the twine, when hanging by the weight of the Grab Ball, is reachable by the seated driver, next to their elbow, whereas;
b) the control disc, with its jamming, holding and release properties, has a definite purpose and functions as the main controller to operate the spreader's slide gate discharge chute, whereas;
c) a nylon twine will always pass through the smaller thin slot opening and its larger opening above, whereas;
d) a knot, or protuberant placed in the nylon twine will never go through the smaller thin slot opening, whereas;
e) the same said knot placed in the nylon twine will always pass through the larger opening, whereas;
f) a twine, with same said knot or protuberant when pulled forward by the driver, the affixed knot or protuberance will not pass through the smaller thin slot opening or get stuck, instead, it is forced to rise up the plastic control disc on the 45 degree angle and pass through the larger opening above, whereas;
g) the same said knot, after passing through the larger opening, will immediately fall against the smaller thin slot opening below, on the front side of the control disc, and get held against the thinner slot, whereas;
h) the same said knot will stay immobile against the smaller thin slot opening, because the other end of the nylon twine is connected to the handle lever that is being pulled back with tension created by the Bungee Cord spring that is tied to the connecting rods handle lever, whereas;
i) the same said knot, after the twine is pulled forward by the driver, has caused the fixed knot or protuberant to get held and jammed against the front side of the control disc's lower thin slot, there being, whereas:
j) has already pulled with it the (12) twelve ± inches of nylon twine slack, which has forced the handle lever to push the connecting rod to move the slide gate discharge chute to “close”, whereas;
k) the same said knot, when lifted up by the operator, forces the twine knot to release its hold from the thin slot, as tension from the Bungee Cord spring pulls the twine knot and (12) twelve inches of twine slack backwards through the larger hole above, which instantly causes the handle lever and its connecting rod to pull the slide gate discharge chute “open”.

5. As per claim 1, a device, being the twine, is preferred, comprising; a strong, thin nylon cord, having less stretch and flexible to adapt smoothly when changing directions by the pulleys, whereas; one end is connected to the operator grab ball located at their seat and the other end is connected to the handle lever and its connecting rod.

6. As per claim 1, a device, being the swivel pulleys, comprising; of a wheel with a grooved rim and swivel to smoothly accept and change direction of the nylon twine without snagging, is preferred, whereas;
a) the swivel pulleys are mounted on the metal support shaft and the rotary spreader to direct the twine to finally connect to the handle lever that moves the connecting rod to open or close the slide gate discharge chute.

7. As per claim 1, a device, being the Bungee Cord, comprising: multiple rubber bands that will not rust and lose their tension, is preferred, which has a definite function to the discharge chute operational movement, whereas;
a) a Bungee Cord, holds tension, as well as releases tension on the handle lever and its adjoining connecting rod to open and close the slide gate discharge chute when the twine is pulled or released by the operator, whereas;
b) the Bungee Cord tension, keeps the knot or protuberant held against the front side of the plastic control disc's lower thinner slot until the operator decides to release the twine knot from its hold, there being, the Bungee Cord tension pulls enough nylon twine slack and the knot backwards, through the larger hole, to force the handle lever and its connecting rod to move the slide gate discharge chute to OPEN, whereas;
c) the Bungee Cord tension, when the operator decides to pull the nylon twine forwards from their seat, thereby pulling the (12) inches of slack and the twine knot forwards through the large hole of the plastic control disc, will force the twine connected to the handle lever and its connecting rod to CLOSE the slide gate discharge chute, whereas;
d) the chute will remain closed because the twine knot is now held and jammed within the thin slot and will not release itself due to the pulling tension caused by the Bungee Cord.

8. As per claim 1, a self-installed kit, comprising: all the hardware components required to mount onto the spreader, with the benefit, to be installed by customers who already own these handle lever rotary spreaders, whereas;
a) the hardware kit components never modifies, changes, altars, removes or adds anything to the original manufactured spreaders discharge chute, mechanism or functions; whereas;
b) the components will not void out original manufacturing warrantees, thereby;
c) the entire process and procedure of the hardware kits' purpose is to only move the existing connecting rod backwards or forwards, to change the position of the slide gate discharge chute, and therefore not affecting the original product flow calibration adjustment setting, further;
d) the hardware in the kit never touches the pulling vehicle, whereas;
e) the user never has to drill any steel to mount the hardware, moreover, they only have to drill the soft plastic hopper for fastening, whereas;
f) the entire kit can be removed and reinstalled onto another spreader if the original tow-behind rotary spreader is broken or under repair.

9. As per claim 1, a device, being, the operator Gab Ball, comprising; a small wooden sphere tied to the end of the twine at the driver's seat, whereas;
a) the Grab Ball allows the operator to pull the nylon twine forwards or to release the twine from its hold, there being, the Grab Ball has enough weight to keep the nylon twine hanging at their side so the operator can clutch the Grab Ball even without looking at it.

10. As per claim 5, a device, being, a twine knot or protuberant, that being, is tied or connected to the twine, plays a major part of the inventions operation, whereas;
a) the knot, when held and jammed within the smaller thinner slot on the front side of the control disc, caused by the backwards pulling tension from the Bungee Cord, causes the slide gate discharge chute to stay CLOSED, without any further assistance from the driver, whereas;
b) the knot, when released from its hold by the operator, is pulled backwards by the Bungee Cord tension through the upper large hole in the plastic control disc, which in turn, causes the slide gate discharge chute to stay OPEN, without any further assistance from the driver.

11. As per claim 1, the (L) bracket, is the preferred mounting device, comprising: a (90) degree (L) shaped metal, having a hole on each axis to mount a bolt and have an extra hole to tie off twine, attach a pulley, or Bungee Cord spring, whereas,
a) the bracket loops, on the top of the handle lever, is held with leather strapping and screws to clamp them onto the handle lever, to simplify the installation, without the user having to drill through the heavy steel handle for bolts.

12. A claim is made that the improvement of this invention, of the tow-behind rotary spreader driver seat operated discharge chute control, allows the driver to operate the slide gate chute control while driving, and facing forwards in their seat, whereas;
a) the driver can operate the slide gate discharge chute while standing and filling the hopper with product, as well as closing the chute or aid in moving the slide gate position for cleaning or lubricating purposes, whereas;
b) the beneficial control disc location and method for the discharge chute deployment, allows the operator to immediately close the slide gate discharge chute, directly from their forward seated position, before any harmful poisons or damaging substances can be broadcast onto environmentally sensitive areas or personal property, whereas;
c) the control disc location and method for the discharge chute deployment, benefits the driver, so they can close the slide gate chute when stopped, to prevent the wasting of granular product from pouring out on the ground, whereas;
d) a passenger, or the driver of a two seated all-terrain vehicle (ATV) are both benefited, where either person can use the discharge chute deployment because the support shaft location is transferable to either seat position.
